(19) United States
(12) Patent Application Publication
(10) Pub. No.: US 2017/0109055 A1
(43) Pub. Date: Apr. 20, 2017

(54) CAPACITY PLANNING IN A MULTI-ARRAY STORAGE SYSTEM

(71) Applicant: Pure Storage, Inc., MOUNTAIN VIEW, CA (US)

(72) Inventors: BENJAMIN BOROWIEC, SANTA CLARA, CA (US); ZHUANGZHI LI, BELLEVUE, WA (US); TERENCE NOONAN, VADNAIS HEIGHTS, MN (US); EMANUEL NOIK, PALO ALTO, CA (US); ZHANJIA YANG, REDMOND, WA (US)

(21) Appl. No.: 14/884,332

(22) Filed: Oct. 15, 2015

(51) Int. Cl. G06F 3/06

(52) U.S. Cl. CPC G06F 3/0608; G06F 3/0689; G06F 3/0619; G06F 3/0665; G06F 3/0641

(57) ABSTRACT

Capacity planning in a multi-array system that includes a plurality of storage arrays, includes: receiving data representing projected capacity utilization for at least one of the plurality of storage arrays, where the projected capacity utilization is generated in dependence upon capacity utilization patterns of a plurality of other storage arrays; and presenting the projected capacity utilization.

### BACKGROUND

Field of Technology

The field of technology is data processing, or, more specifically, methods, apparatus, and products for capacity planning in a multi-array storage system.

Description of Related Art

Data centers may include many computing components including servers, network devices, and storage arrays. As the need for storage of large amounts of data and efficient access to that data increases, storage array technology is advancing. Such storage arrays may provide persistent storage for any number of computing devices in a data center. Capacity utilization of different storage arrays may grow at different rates. Projecting capacity utilization may provide a user of a storage array with valuable knowledge.

### SUMMARY

Methods, apparatus, and products for capacity planning in a multi-array system that includes a plurality of storage arrays are described in this specification. Such capacity planning may include: receiving data representing projected capacity utilization for at least one of the plurality of storage arrays, where the projected capacity utilization is generated in dependence upon capacity utilization patterns of a plurality of other storage arrays; and presenting the projected capacity utilization.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system configured for capacity planning in a multi-array storage system according to embodiments of the present invention.

FIG. 2 sets forth a block diagram of several example computers useful for capacity planning in a multi-array storage system according to embodiments of the present invention.

FIG. 3 sets forth a block diagram of an example storage controller of a storage array.

FIG. 4 sets forth an example presentation of projected capacity utilization for a storage array in a multi-array storage system according to embodiments of the present invention.

FIG. 5 sets forth another example presentation of projected capacity utilization for a storage array in a multi-array storage system according to embodiments of the present invention.

FIG. 6 sets forth another example presentation of projected capacity utilization for a storage array in a multi-array storage system according to embodiments of the present invention.

FIG. 7 sets forth a flow chart illustrating an exemplary method for capacity planning in a multi-array storage system according to embodiments of the present invention.

FIG. 8 sets forth a flow chart illustrating another exemplary method for capacity planning in a multi-array storage system according to embodiments of the present invention.

FIG. 9 sets forth a flow chart illustrating another exemplary method for capacity planning in a multi-array storage system according to embodiments of the present invention.

FIG. 10 sets forth a flow chart illustrating another exemplary method for capacity planning in a multi-array storage system according to embodiments of the present invention.

FIG. 11 sets forth a flow chart illustrating another exemplary method for capacity planning in a multi-array storage system according to embodiments of the present invention.

FIG. 12 sets forth a flow chart illustrating another exemplary method for capacity planning in a multi-array storage system according to embodiments of the present invention.

FIG. 13 sets forth a flow chart illustrating another exemplary method for capacity planning in a multi-array storage system according to embodiments of the present invention.

### DETAILED DESCRIPTION OF EXEMPLARY EMBODIMENTS

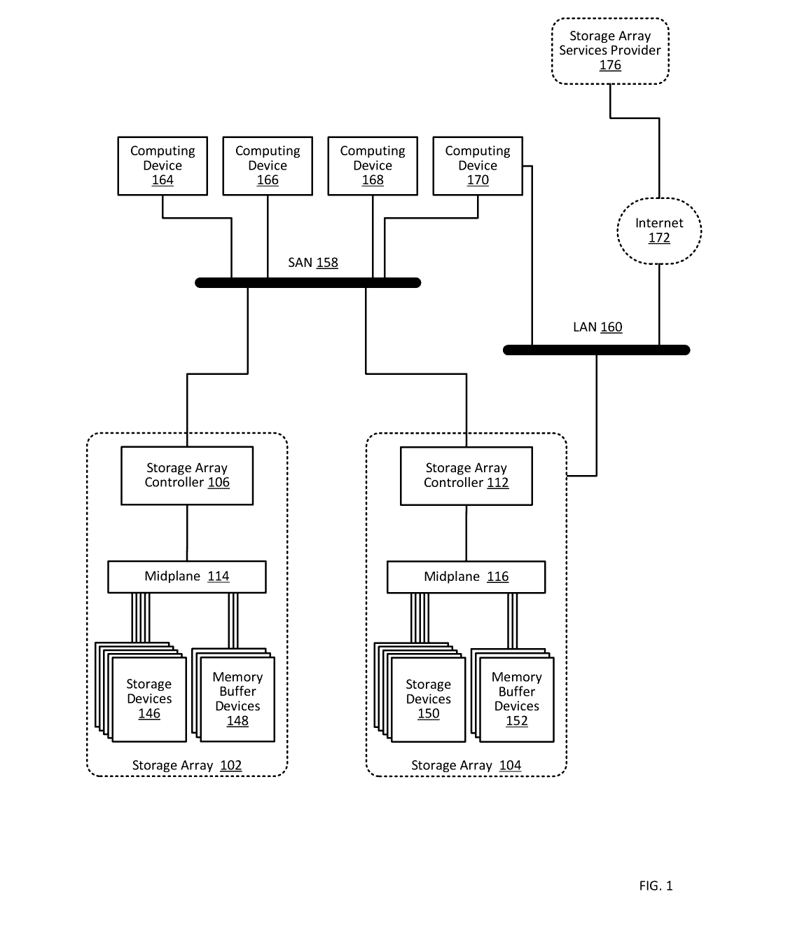

Exemplary methods, apparatus, and products for capacity planning in a multi-array storage system in accordance with the present invention are described with reference to the accompanying drawings, beginning with FIG. 1.

FIG. 1 sets forth a block diagram of a system configured for capacity planning in a multi-array storage system according to embodiments of the present invention. The system of FIG. 1 includes a number of computing devices (164, 166, 168, 170). Such computing devices may be implemented in a number of different ways. For example, a computing device may be a server in a data center, a workstation, a personal computer, a notebook, or the like.

The computing devices (164-170) in the example of FIG. 1 are coupled for data communications to a number of storage arrays (102, 104) through a storage area network (SAN) (158) as well as a local area network (160) (LAN). The SAN (158) may be implemented with a variety of data communications fabrics, devices, and protocols. Example fabrics for such a SAN may include Fibre Channel, Ethernet, Infiniband, SAS (Serial Attached Small Computer System Interface), and the like. Example data communications protocols for use in such a SAN (158) may include ATA (Advanced Technology Attachment), Fibre Channel Protocol, SCSI, iSCSI, HyperSCSI, and others. Readers of skill in the art will recognize that a SAN is just one among many possible data communications couplings which may be implemented between a computing device and a storage array. Any other such data communications coupling is well within the scope of embodiments of the present invention.

The local area network (160) of FIG. 1 may also be implemented with a variety of fabrics and protocols. Examples of such fabrics include Ethernet (802.3), wireless (802.11), and the like. Examples of such data communications protocols include TCP (Transmission Control Protocol), UDP (User Datagram Protocol), IP (Internet Protocol), HTTP (HyperText Transfer Protocol), WAP (Wireless Access Protocol), HDTP (Handheld Device Transport Protocol), SIP (Session Initiation Protocol), RTP (Real Time Protocol) and others as will occur to those of skill in the art.

The example storage arrays (102, 104) of FIG. 1 provide persistent data storage for the computing devices. Each storage array (102, 104) includes a storage controller (106, 112). The storage controller is a module of automated computing machinery comprising computer hardware, computer software, or a combination of computer hardware and software. The storage controller may be configured to carry out various storage-related tasks. Such tasks may include writing data received from a computing device to storage, erasing data from storage, retrieving data from storage to provide to a computing device, monitoring and reporting of disk utilization and performance, performing RAID (Redundant Array of Independent Drives) or RAID-like data redundancy operations, compressing data, encrypting data, and so on.

Each storage controller (106, 112) may be implemented in a variety of ways, including as an FPGA (Field Programmable Gate Array), a PLC (Programmable Logic Chip), an ASIC (Application Specific Integrated Circuit), or computing device that includes discrete components such as a central processing unit, computer memory, and various adapters. Each storage controller (106, 112) may, for example, include a data communications adapter configured to support communications via the SAN (158) and the LAN (160). Only one of the storage controllers (112) in the example of FIG. 1 is depicted as coupled to the LAN (160) for data communications for clarity. Readers should understand that both storage controllers (106, 112) are independently coupled to the LAN (160). Each storage controller (106, 112) may also, for example, include an I/O controller or the like that couples the storage controller (106, 112) for data communications, through a midplane (114), to a number of storage devices (146, 150), and a number of write buffer devices (148, 152) devices.

Each write buffer device (148, 152) may be configured to receive, from the storage controller (106, 112), data to be stored in the storage devices (146). Such data may originate from any one of the computing devices (164-170). In the example of FIG. 1, writing data to the write buffer device may be carried out more quickly than writing data to the storage device. The storage controller (106, 112) may be configured to effectively utilize the write buffer devices (148, 152) as a quickly accessible redundant buffer for data destined to be written to storage. In this way, if the storage device to which the data is to be written fails or if the write does not complete, the write buffer device may maintain the data to be written during a retry of the write or during failover of the storage device to another location. That is, the write buffer device may provide redundancy for the storage devices.

A ‘storage device’ as the term is used in this specification refers to any device configured to record data persistently. The term ‘persistently’ as used here refers to a device's ability to maintain recorded data after loss of a power source. Examples of storage devices may include mechanical, spinning hard disk drives, Solid-state drives (“Flash drives”), and the like.

In addition to being coupled to the computing devices through the SAN (158), the storage arrays may also be coupled to the computing devices through the LAN (160) and to one or more cloud service providers through the Internet (172). The term ‘cloud’ as used in this specification refers to systems and computing environments that provide services to user devices through the sharing of computing resources through a network. Generally, the user device is unaware of the exact computing resources utilized by the cloud system to provide the services. Although in many cases such ‘cloud’ environments or systems are accessible via the Internet, readers of skill in the art will recognize that any system that abstracts the use of shared resources to provide services to a user through any network may be considered a cloud-based system.

One example cloud service in FIG. 1 is a storage array services provider (176). The storage array service provider (176) may be configured to provide various storage array services such as reporting of storage array performance characteristics, configuration control of the storage arrays, and the like. The storage array services provider may rely on modules executing on the storage array itself to gather or process such data.

The system of FIG. 1 may be configured, according to embodiments of the present invention, to provide capacity planning in a multi-array storage system. The storage array services provider (176) in the example of FIG. 1 may receiving data representing projected capacity utilization for at least one of the of storage arrays (102, 104). Capacity as the term is used in this specification refers to the amount of available data storage of a storage array. Capacity utilization refers to the amount of data storage that is currently storing data and thus, not available for data storage. Projected capacity utilization refers to a forecast or estimate of a capacity utilization over time. Given knowledge of such capacity utilization projection, an administrator of a storage array environment may be able to better plan for data storage growth. In some instances, for example, capacity planning may include providing various recommendations as to particular methods for alleviating the rate of capacity utilization over time.

Such a projected capacity utilization may be generated in various ways. In some embodiments, the projected capacity utilization may be generated, for example, in dependence upon capacity utilization patterns of a plurality of other storage arrays. That is, the projected capacity utilization may take into account the typical usage patterns of the storage array as well as typical usage patterns of other storage arrays in the multi-array storage system.

Generation of the projected capacity utilization for a storage array may be carried out by various entities in the example of FIG. 1. For example, the storage array services provider, or some other cloud-based services provider, may generate the projected capacity utilization. In some embodiments, the storage array controller (106, 112) of one of the storage arrays (102, 104) may be configured to generate projected capacity utilization. Any entity may generate the projected capacity utilization and provide the projected capacity utilization to the storage array services provider (176).

The example storage array services provider (176) may also present the projected capacity utilization. Such a presentation may be carried out in various ways including, for example, by rendering the projected capacity utilization on a graph within a web page exposed to a user's web browser.

The arrangement of computing devices, storage arrays, cloud-based service providers, networks and other devices making up the exemplary system illustrated in FIG. 1 are for explanation, not for limitation. Systems useful according to various embodiments of the present invention may include different configurations of servers, routers, switches, computing devices, and network architectures, not shown in FIG. 1, as will occur to those of skill in the art.

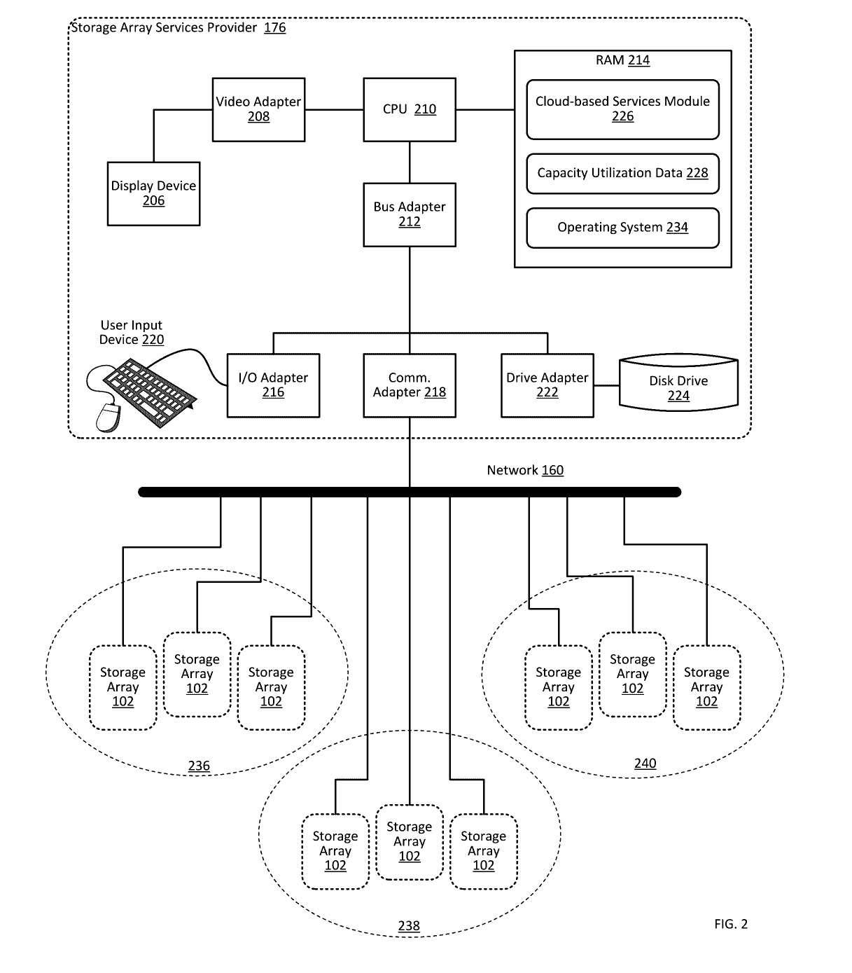

Capacity planning in a multi-array storage system in accordance with embodiments of the present invention is generally implemented with computers. In the system of FIG. 1, for example, all the computing devices (164-170), storage controllers (106, 112), and storage array services provider (176) may be implemented, to some extent at least, as computers. For further explanation, therefore, FIG. 2 sets forth a block diagram of several example computers useful for capacity planning in a multi-array storage system according to embodiments of the present invention. The example computers in FIG. 2 include a storage array services provider (176).

The storage array services provider (176) of FIG. 2 includes at least one computer processor (210) or ‘CPU’ as well as random access memory (214) (‘RAM’) which is connected through a high speed memory bus and bus adapter (212) to processor (210) and to other components of the storage array services provider (176). Stored in RAM (214) is a cloud-based services module (226), a module of computer program instructions that when executed causes the storage array services provider (176) to provide capacity planning in a multi-array storage system. The cloud-based services module (226) may receive data (228) representing projected capacity utilization for at least one of the plurality of storage arrays. In the example of FIG. 2, the projected capacity utilization (228) may be generated in dependence upon capacity utilization patterns of a plurality of other storage arrays (236, 238, 240). Because the storage array services provider (176) may be implemented as a cloud-based service provider, many storage arrays may occasionally or periodically report to the storage array services provider (176). In addition, in some embodiments such storage arrays may be owned by separate entities. To that end, in some embodiments, the capacity utilization patterns upon which the projected capacity utilization of a particular storage array is generated may be patterns provided by storage arrays other than those owned by the owner of the particular storage array.

The cloud-based services module (226) of FIG. 2 may also present the projected capacity utilization. In some embodiments, the cloud-based service module (226) may present the projected capacity utilization through a user-facing web page accessible through one or more web services, Application Programming Interfaces (APIs), data communications networks, data communications protocols, and any combination thereof

Also stored in RAM (214) of the example storage array services provider (176) is an operating system (234). Examples of operating systems useful in computers configured for capacity planning in a multi-array storage system according to embodiments of the present invention include UNIX™, Linux™, Microsoft Windows™, and others as will occur to those of skill in the art. The operating system (234) and the cloud-based storage array services module (226) in the example of FIG. 2 are shown in RAM (168), but many components of such software typically are stored in non-volatile memory also, such as, for example, on a disk drive (224). Likewise, the modules depicted in RAM (238, 240) of the storage array (102) and client-side user computer (204) may be stored in non-volatile memory.

The storage array services provider (176) of FIG. 2 also includes disk drive adapter (222) coupled through an expansion bus and bus adapter (212) to the processor (210) and other components of the storage array services provider (176). Disk drive adapter (222) connects non-volatile data storage to the storage array services provider (176) in the form of disk drive (224). Disk drive adapters may be implemented in a variety of ways including as SATA (Serial Advanced Technology Attachment) adapters, PATA (Parallel ATA) adapters, Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory), RAM drives, and so on, as will occur to those of skill in the art.

The example storage array services provider (176) of FIG. 2 includes one or more input/output (‘I/O’) adapters (216). I/O adapters implement user-oriented input/output through, for example, software drivers and computer hardware for controlling output to display devices such as computer display screens, as well as user input from user input devices (220) such as keyboards and mice. The example storage array services provider (176) of FIG. 2 also includes a video adapter (208), which is an example of an I/O adapter specially designed for graphic output to a display device (206) such as a display screen or computer monitor. Video adapter (208) is connected to the processor (210) through a high speed video bus.

The exemplary storage array services provider (176) of FIG. 2 includes a communications adapter (218) for data communications with the storage arrays (102) through the network (160). Such data communications may be carried out through data communications networks such as IP data communications networks, and in other ways as will occur to those of skill in the art. Communications adapters implement the hardware level of data communications through which one computer sends data communications to another computer, directly or through a data communications network. Examples of such communications adapters useful include modems for wired dial-up communications, Ethernet (IEEE 802.3) adapters for wired data communications, and 802.11 adapters for wireless data communications.

Readers of skill in the art will recognize that the components of the storage array services provider (176) as depicted in FIG. 2 are example computing components only. Such a storage array services provider (176) may be configured in various ways including, for example, as a server. Such a server may not include the I/O adapters, the driver adapters, display devices, video adapters and the like.

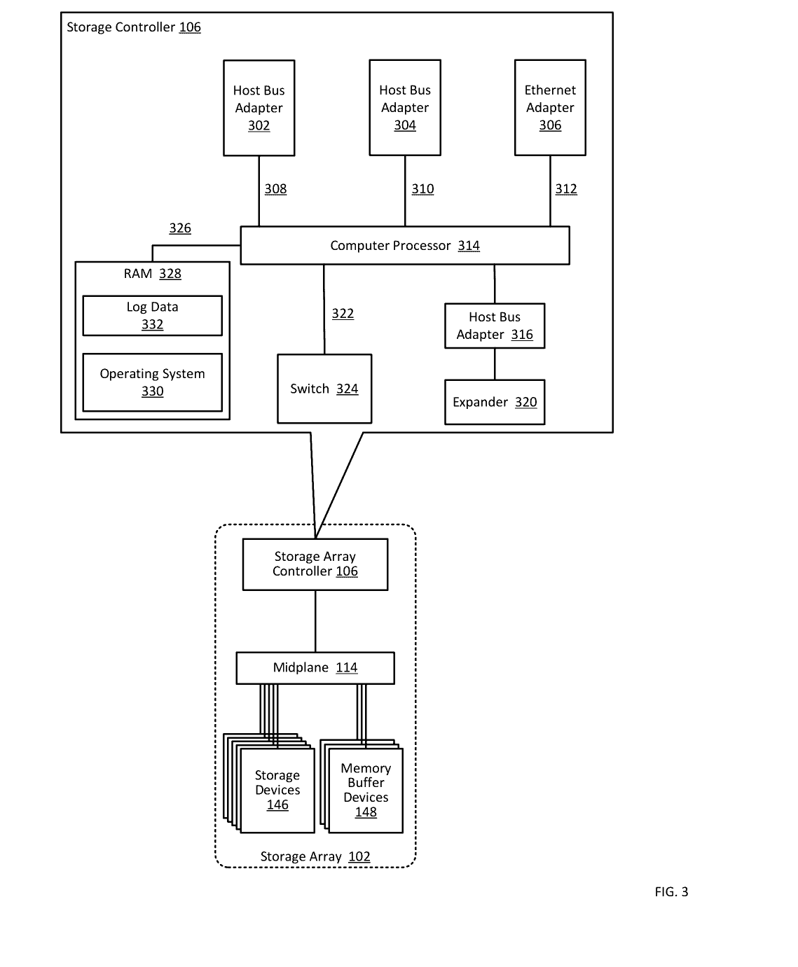

As mentioned above, a storage array (102) may also be implemented, at least to some extent, as a computer. For further explanation, therefore, FIG. 3 sets forth a block diagram of an example storage controller (106) of a storage array (102). The example storage controller includes a computer processor (314). The computer processor is coupled to RAM (214) through a DDR4 (Double-Data Rate 4) bus. Stored in RAM (214) is an operating system (330) and log data (332). Such log data may include events that occur within the storage array that are reported to the storage controller from firmware of the components of the storage array or events detected by the operating system (330) of the storage controller.

The processor (314) is also coupled for data communications through PCIe (Peripheral Component Interface express) links (308, 310, 312, 322) to several Fibre Channel host bus adapters (302, 304), an Ethernet adapter (306), and a PCIe switch (324). The Fibre Channel host bus adapters (308, 310) may couple the storage controller to a storage area network, such the SAN (158) depicted in the example of FIGS. 1 and 2. The Ethernet adapter (306) may couple the storage controller to a local area network such as the LAN (160) depicted in the example of FIGS. 1 and 2. The PCIe switch (324) may provide data communications across other PCI links through the midplane to PCI endpoints, such as storage devices or write buffer devices. Likewise, the processor (314) is also coupled through a SAS (Serial Attached SCSI) host bus adapter (316) to a SAS expander (320). The SAS expander may provide SAS connections between the computer processor (314) and other devices through the midplane.

Readers of skill in the art will recognize that these components, protocols, adapters, and architectures are for illustration only, not limitation. Such a storage controller may be implemented in a variety of different ways. Each such way is well within the scope of the present invention.

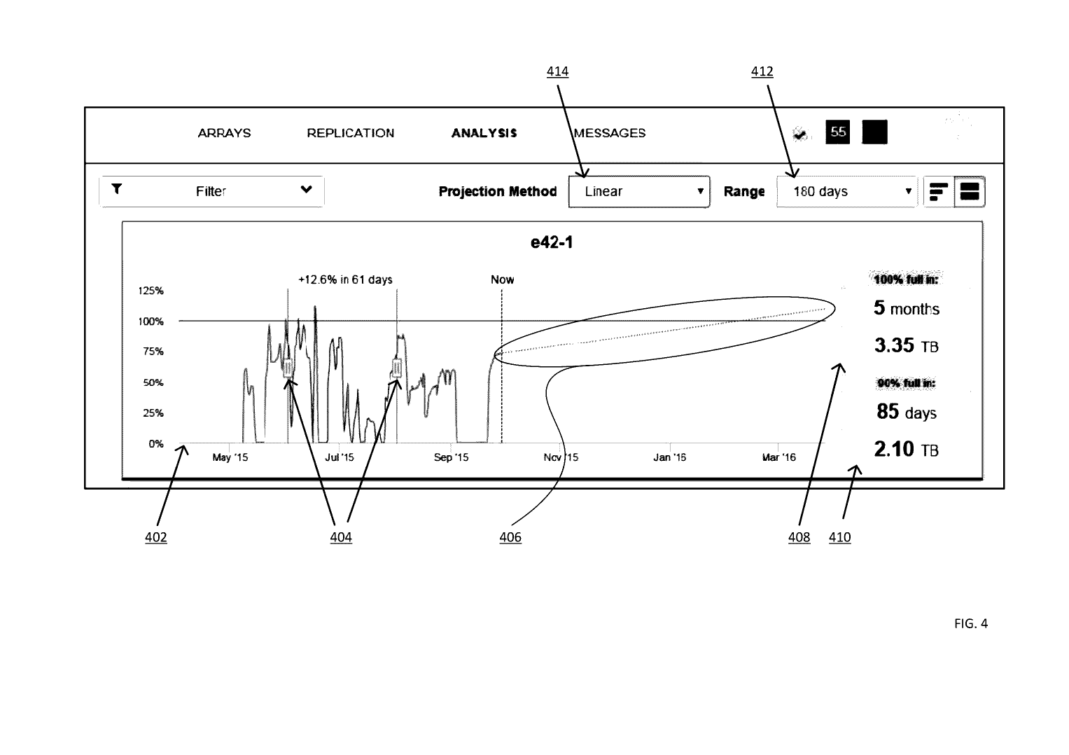

For further explanation, FIG. 4 sets forth an example presentation of projected capacity utilization for a storage array in a multi-array storage system according to embodiments of the present invention. The example of FIG. 4 sets forth a graph (402) of capacity utilization of a storage array identified as “e42-1.” The left half of the graph represents historical capacity utilization. That is, the data represented prior to (to the left of) the “Now” vertical line, is actual capacity utilization of the storage array. The data presented from the “Now” vertical line and on, represents projected capacity utilization (406).

The example presentation in FIG. 4 includes several user input objects. For example, the “Range” object (412) is a drop down selection box from which a user may select an amount of time to which to project capacity utilization of the storage array. In some embodiments, the user may select a date, rather than a range. A change in the selection of the range (412) may cause a module to regenerate or recalculate the projected capacity utilization based on the newly selected range.

The example presentation of FIG. 4 also includes a “Projection Method” object (414) which is implemented as a drop down selection box. A user may select one of a variety of algorithms with which the projected capacity utilization may be calculated. Projection algorithms may be mathematical formulas configured to calculate projected capacity given various data inputs. Examples of such algorithms may include a linear algorithm that calculates projected capacity utilization as a line having a slope calculated from historical capacity utilization patterns, a ‘season’ algorithm in which one period of historical capacity utilization is repeated as the projected capacity utilization, and others as will occur to readers of skill in the art. A change in the selection may cause a module to regenerate or recalculate the projected capacity utilization based on the newly selected projected method.

The example presentation of FIG. 4 also includes two movable sliders (404). These sliders provide a user the ability select a window of historical capacity utilization to use a basis of the projected capacity utilization calculation. In some instances, for example, capacity utilization may be atypical during one time frame while being more typical during another. A user may select the typical time frame to base the projected capacity utilization calculation on rather than the atypical time frame through use of the sliders (404). Any change in the selection of the historical capacity utilization time range or window may cause a module to recalculate the projected capacity utilization.

In the example of FIG. 4, several graphical user interface objects, such as the sliders (404), the drop down selection box for the projection method (414), and the drop down selection box for the range (412) are depicted. A change via user input through any of these objects may result in a recalculation or regeneration of the projected capacity utilization. Readers of skill in the art will recognize that, in addition to the examples provided here, many other objects may be included in a presentation of projected capacity utilization in accordance with embodiments of the present invention and any such objected may be manipulated through user input to cause a regeneration or recalculation of projected capacity utilization based on new parameters prompted by the manipulation of that object. For example, sliding either of the sliders (404) may change the portion of historical capacity utilization used as a basis for projecting capacity utilization.

In some embodiments, any one or more of these objects may be ‘locked’ from user interaction. Consider, for example, the “Now” line. In some embodiments, the “Now” line may be adjustable by a user. That is, a user may ‘grab’ the “Now” line and slide the line left or right. Such a change may result in recalculating or regenerating the capacity utilization. Sliding the “Now” line to the right, for example, may increase the amount of historical capacity utilization displayed on the graph, while reducing the amount of time to project capacity utilization. Sliding the “Now” line to the left may increase the amount of time to which to project capacity utilization and reduce the amount of historical capacity utilization to display in the graph. In some embodiments, by contrast, the “Now” line may be locked or ‘fixed’ such that a user may not interact with the object.

In addition to the graph (402), the example presentation of FIG. 4 also includes several critical point projections. In this example, the presentation includes a projection of how long it will take for the capacity utilization to reach 90% (410) and then another projection of how long it will take for the capacity utilization to reach 100% (408).

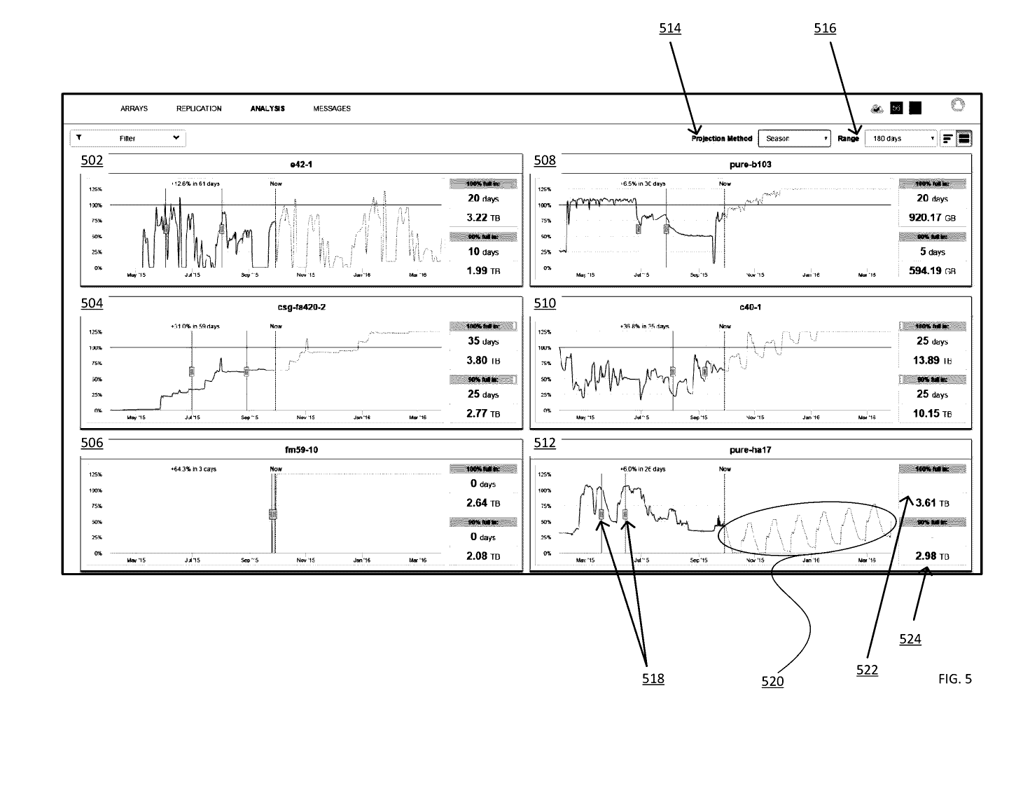

For further explanation, FIG. 5 sets forth another example presentation of projected capacity utilization for a storage array in a multi-array storage system according to embodiments of the present invention. In the example presentation of FIG. 5, capacity utilization graphs (502, 504, 506, 508, 510, 512) for a number of different storage arrays are depicted. In this way, a user that manages multiple storage arrays may view the capacity utilization metrics of each of the storage arrays in a single view.

Each of the graphs (502-512) in the example of FIG. 5 includes historical capacity utilization as well as projected capacity utilization. The projected capacity utilization was generated in part in dependence upon the selected projection method (514), “Season,” for a selected time range (516) of 180 days.

Each of the graphs in the example of FIG. 5 includes similar components. Graph (512), as an example, includes a selection of a portion of the historical capacity utilization (518) upon which the projected capacity utilization (520) is based at least in part. Further, each graph includes critical points at which the capacity utilization is projected to be 90% (524) and 100% (520) of total capacity. Within the selected time range (516) for projection, the capacity utilization of ‘pure-ha17’ is not projected to reach 90% or 100% capacity utilization.

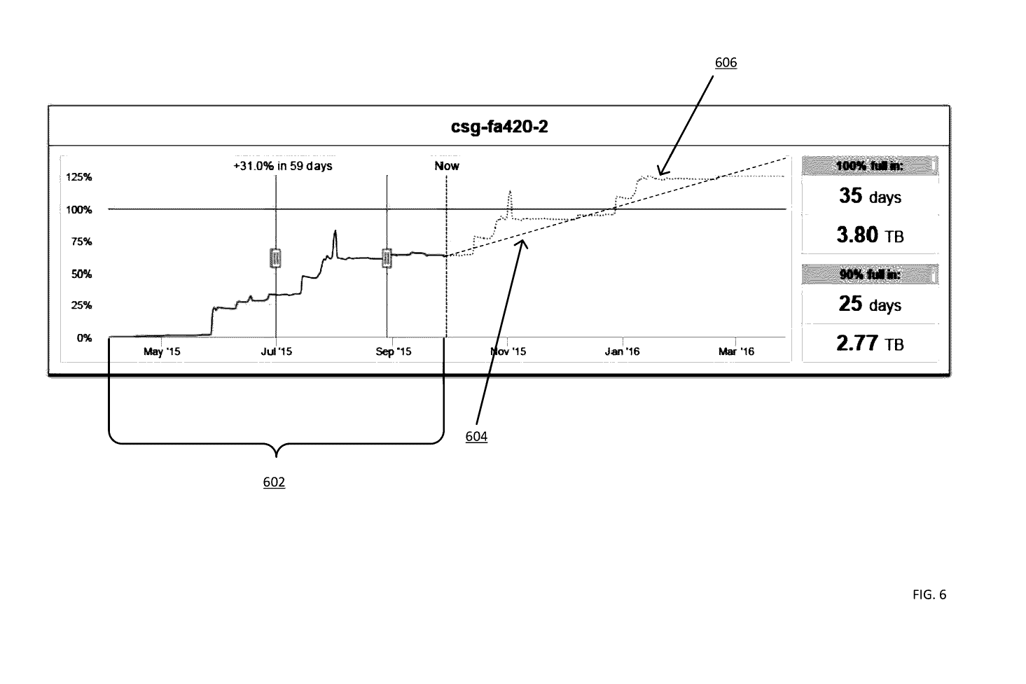

For further explanation, FIG. 6 sets forth another example presentation of projected capacity utilization for a storage array in a multi-array storage system according to embodiments of the present invention. In the example presentation of FIG. 5, a capacity utilization graphs is presented for a storage array referred to as ‘csg-fa420-2.’

The capacity utilization graph includes historical capacity utilization (602) as well as projected capacity utilization (604) in the form of a dashed line. In addition to historical capacity utilization (602) and the projected capacity utilization (604), the example presentation of FIG. 6 also includes a historical capacity utilization (606) that is superimposed on the projected capacity utilization. The superimposed historical capacity utilization enables a user to more easily compare and contrast the projected capacity utilization and historical capacity utilization. In instances in which the two differ greatly, the user may select a different algorithm or a different historical time period to alter the projection of capacity utilization to more closely resemble the superimposed historical time period.

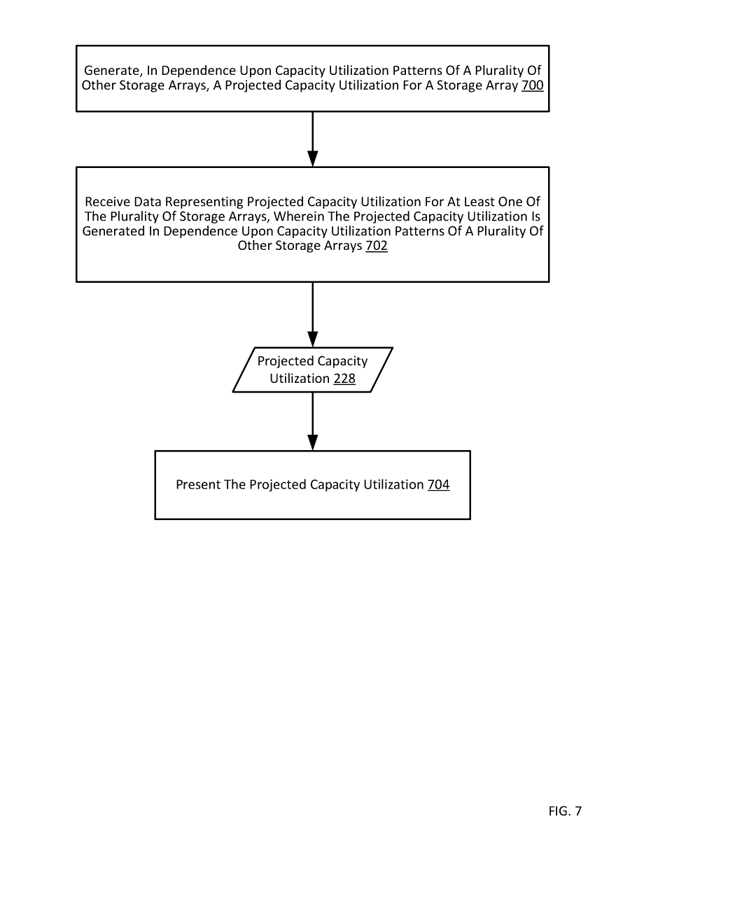

For further explanation, FIG. 7 sets forth a flow chart illustrating an exemplary method for capacity planning in a multi-array storage system according to embodiments of the present invention. Portions of the FIG. 7 may be carried out by a cloud-based storage array services provider (176 in the example of FIG. 1), another cloud service module, a module executed by the storage controller of a storage array, or any combination thereof.

The method of FIG. 7 includes generating (700), in dependence upon capacity utilization patterns of a plurality of storage arrays, a projected capacity utilization for a particular storage array. Such a generation may be carried out by various modules in a variety of ways. In some embodiments, a cloud-based services module may periodically receive data from the plurality of storage arrays and the particular storage array. The data may include, among other items, the current capacity utilization at the time of the data transfer. Based on a projection algorithm, a range in which to project capacity utilization, the historical capacity utilization patterns of the plurality of storage arrays, the historical capacity utilization patterns of the particular storage, the cloud-based services module may calculate a projected capacity utilization for the particular storage array. Once generated, the cloud-based services module may provide the projected capacity utilization to another module, such as the storage array services module (176 of FIG. 1).

The method of FIG. 7 also includes receiving (702) data (228) representing projected capacity utilization for the particular storage array. Receiving (702) such data (228) may be carried out in a variety of ways including, for example, as a parameter of a function call, as a payload of a data communications message, through an API, and in other ways as will occur to readers of skill in the art.

The method of FIG. 7 also includes presenting (704) the projected capacity utilization. Presenting (704) the projected capacity utilization may be carried out in many different ways. For example, a storage array services module may render the projected capacity utilization as part of a line graph included in a web page accessible to a user, such as those depicted in the previous figures. The storage array services module may alternatively present bar graphs that depict capacity and enable a user to view the contents of the current capacity utilization along with the projected capacity utilization. Such a projection may also include a forecast of the contents of the projected capacity utilization. That is, if a storage array includes data current stores data from two different workloads at a 1:10 ratio, the presentation may include an indication that the projected capacity utilization also includes the same ratio.

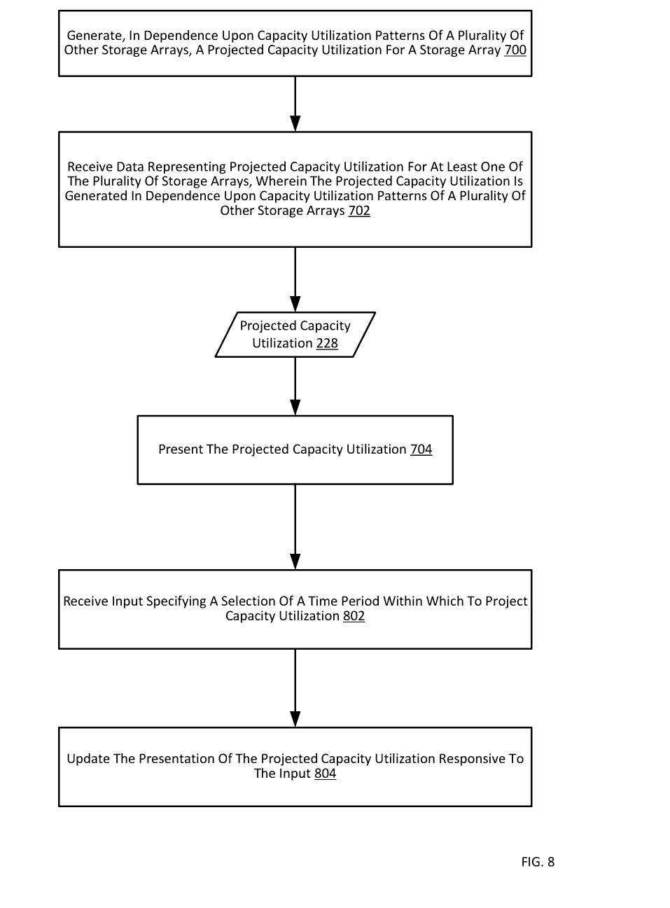

For further explanation, FIG. 8 sets forth a flow chart illustrating another exemplary method for capacity planning in a multi-array storage system according to embodiments of the present invention. The method of FIG. 8 is similar to the method of FIG. 7 in that portions of the FIG. 8 may be carried out by a cloud-based storage array services provider (176 in the example of FIG. 1), another cloud service module, a module executed by the storage controller of a storage array, or any combination thereof. The method of FIG. 8 is also similar to the method of FIG. 7 in that the method of FIG. 8 includes receiving (702) data representing projected capacity utilization for at least one of the plurality of storage arrays, where the projected capacity utilization is generated (700) in dependence upon capacity utilization patterns of a plurality of other storage arrays and presenting (704) the projected capacity utilization.

The method of FIG. 8 differs from the method of FIG. 7, however, in that the method of FIG. 8 also includes receiving (802) input specifying a selection of a time period within which to project capacity utilization and updating (804) the presentation of the projected capacity utilization responsive to the input. Receiving (802) input specifying a selection of a time period may be carried out by receiving user input through a drop down selection box, receiving user input through a command line interface, receiving user input through a movement of a graphical user interface (‘GUI’) slider on a graph representing a timeline, and the like. Updating (804) the presentation of the projected capacity utilization may be carried out in a variety of ways including one or more modules recalculating the projected capacity utilization of the storage array with a new time period as an input to the algorithm used to project the capacity utilization and re-rendering a graph that includes the recalculated projected capacity utilization.

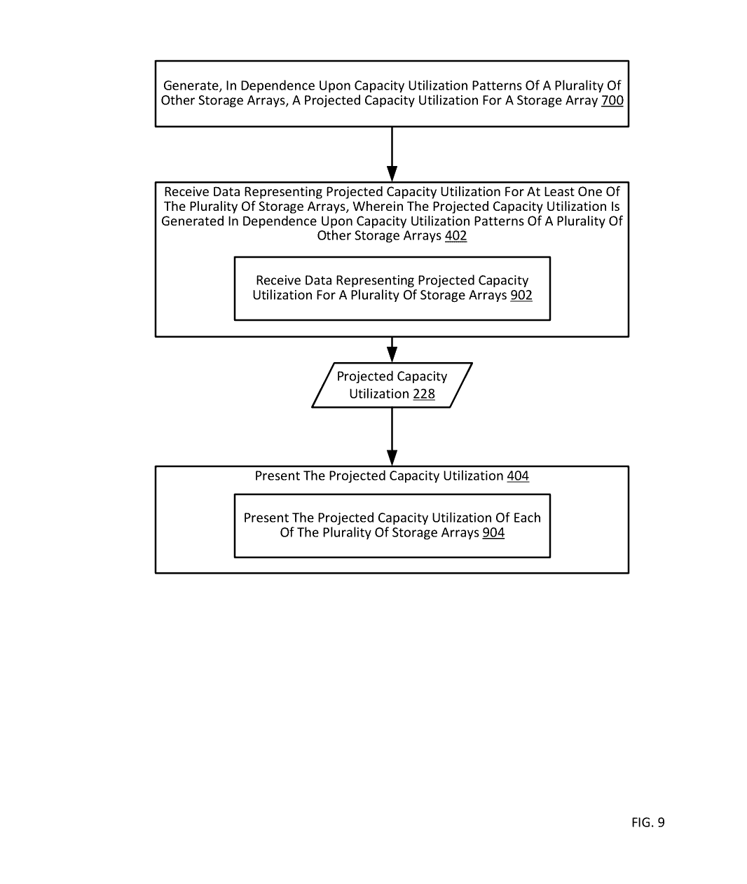

For further explanation, FIG. 9 sets forth a flow chart illustrating another exemplary method for capacity planning in a multi-array storage system according to embodiments of the present invention. The method of FIG. 9 is similar to the method of FIG. 7 in that portions of the FIG. 9 may be carried out by a cloud-based storage array services provider (176 in the example of FIG. 1), another cloud service module, a module executed by the storage controller of a storage array, or any combination thereof. The method of FIG. 9 is also similar to the method of FIG. 7 in that the method of FIG. 9 includes receiving (702) data representing projected capacity utilization for at least one of the plurality of storage arrays, where the projected capacity utilization is generated (700) in dependence upon capacity utilization patterns of a plurality of other storage arrays and presenting (704) the projected capacity utilization.

The method of FIG. 9 differs from the method of FIG. 7, however, in that in the method of FIG. 9 receiving (402) data representing projected capacity utilization for at least one of the plurality of storage arrays includes receiving (902) data representing projected capacity utilization for a plurality of storage arrays. That is, in some embodiments, a user may manage multiple storage arrays and, as such, the module carrying out steps of FIG. 9 may be configured to receive data from each and every one of those storage arrays.

Also in the method of FIG. 9, presenting (404) the projected capacity utilization includes presenting (904) the projected capacity utilization of each of the plurality of storage arrays. As shown above in FIG. 5, presenting the projected capacity utilization of a plurality of storage arrays may be carried out by presenting a graph of capacity utilization that includes the projected capacity utilization for each of the storage arrays within a web page or other GUI. In this way, a user may view the historical and projected capacity utilization of many or all of the storage arrays that the user manages at the same time, within a single web page, or within a single view.

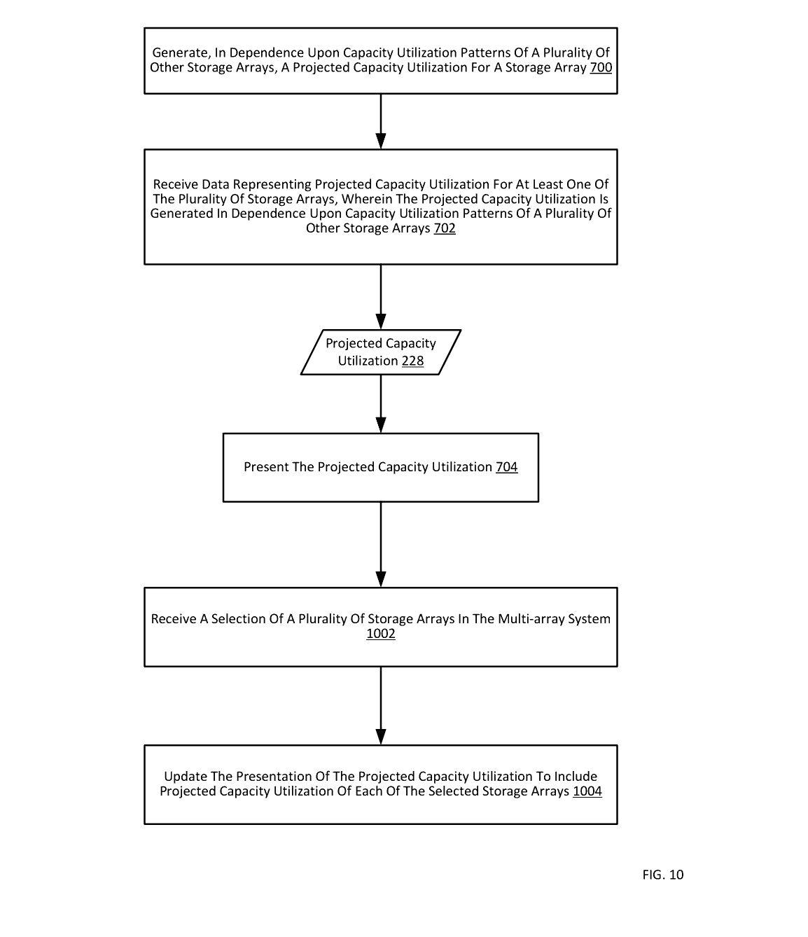

For further explanation, FIG. 10 sets forth a flow chart illustrating another exemplary method for capacity planning in a multi-array storage system according to embodiments of the present invention. The method of FIG. 10 is similar to the method of FIG. 7 in that portions of the FIG. 10 may be carried out by a cloud-based storage array services provider (176 in the example of FIG. 1), another cloud service module, a module executed by the storage controller of a storage array, or any combination thereof. The method of FIG. 10 is also similar to the method of FIG. 7 in that the method of FIG. 10 includes receiving (702) data representing projected capacity utilization for at least one of the plurality of storage arrays, where the projected capacity utilization is generated (700) in dependence upon capacity utilization patterns of a plurality of other storage arrays and presenting (704) the projected capacity utilization.

The method of FIG. 10 differs from the method of FIG. 7, however, in that the method of FIG. 10 includes receiving (1002) a selection of a plurality of storage arrays in the multi-array system and updating (1004) the presentation of the projected capacity utilization to include projected capacity utilization of each of the selected storage arrays. In some embodiments, a single graph may be presented that depicts the capacity utilization for a single storage array. In some embodiments, a user may wish to view multiple capacity utilization graphs superimposed upon one another or view a graph for each storage array in a subset of selected storage arrays. In the former example, superimposing projected capacity utilization of one storage array over another may be useful when one storage array is a replication target of the other for example.

Receiving a selection of a plurality of storage arrays may be carried out in a variety of ways. In some embodiments, for example, a list of storage arrays may be positioned below a graph of capacity utilization for a single storage array. Each entry in the list may include a GUI check box that, when ‘clicked’ or selected, causes the projected capacity utilization of the storage array in that entry to be superimposed on the graph. Readers will immediately recognize that there may be many other example embodiments for a user's selection of a plurality of storage arrays. Each such embodiment is well within the scope of the present disclosure.

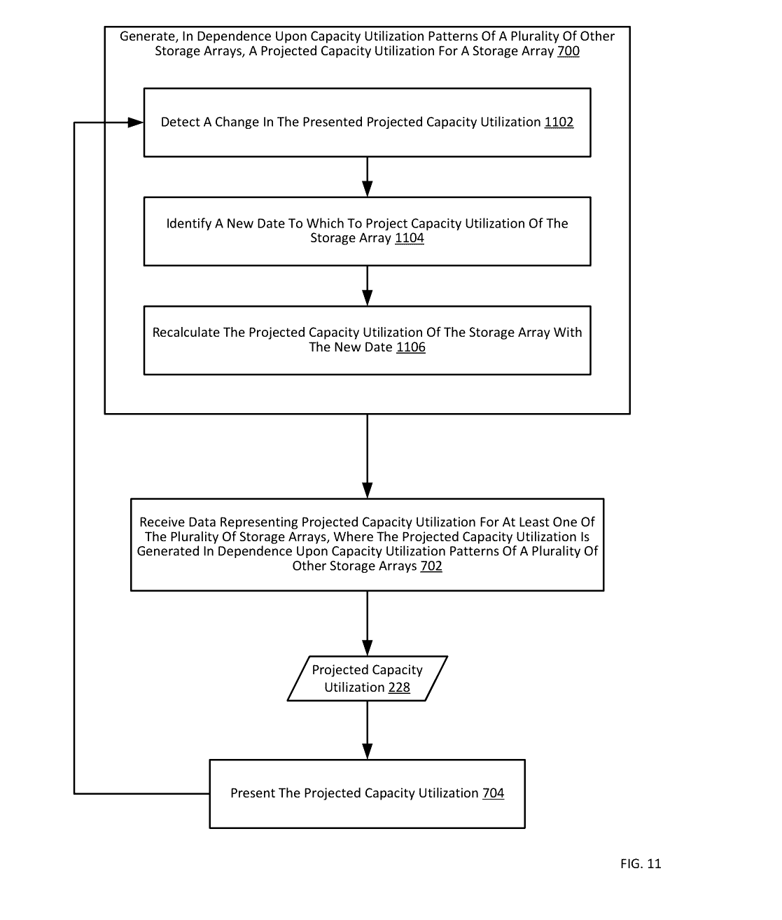

For further explanation, FIG. 11 sets forth a flow chart illustrating another exemplary method for capacity planning in a multi-array storage system according to embodiments of the present invention. The method of FIG. 11 is similar to the method of FIG. 7 in that portions of the FIG. 11 may be carried out by a cloud-based storage array services provider (176 in the example of FIG. 1), another cloud service module, a module executed by the storage controller of a storage array, or any combination thereof. The method of FIG. 11 is also similar to the method of FIG. 7 in that the method of FIG. 11 includes receiving (702) data representing projected capacity utilization for at least one of the plurality of storage arrays, where the projected capacity utilization is generated (700) in dependence upon capacity utilization patterns of a plurality of other storage arrays and presenting (704) the projected capacity utilization.

The method of FIG. 11 differs from the method of FIG. 7, however, in that in the method of FIG. 11, generating (700) a projected capacity utilization for a storage array includes: detecting (1102) a change in the presented projected capacity utilization, and responsive to the change, identifying (1104) a new date to which to project capacity utilization of the storage array and recalculating (1106) the projected capacity utilization of the storage array with the new date. Detecting (1102) a change in the presented projected capacity utilization may be carried out by detecting a user ‘grabbing’ through a GUI the a portion of a graph of projected capacity utilization (such as the “Now” line in the examples above) and moving the grabbed portion to the left. In such a way, the time period within which the graph reflects projected capacity utilization is effectively increased while reducing the amount of historical capacity utilization displayed. In response to that change, the module responsible for generating the projected capacity utilization may identify the new date to which to capacity utilization is to be projected and recalculate accordingly.

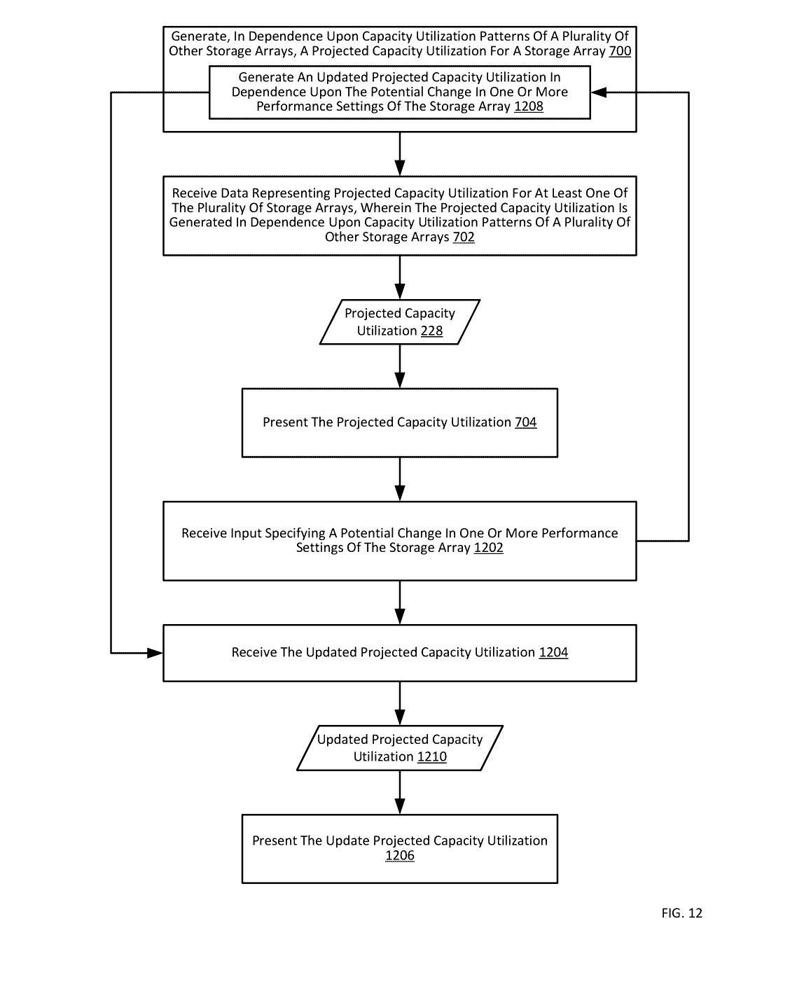

For further explanation, FIG. 12 sets forth a flow chart illustrating another exemplary method for capacity planning in a multi-array storage system according to embodiments of the present invention. The method of FIG. 12 is similar to the method of FIG. 7 in that portions of the FIG. 12 may be carried out by a cloud-based storage array services provider (176 in the example of FIG. 1), another cloud service module, a module executed by the storage controller of a storage array, or any combination thereof. The method of FIG. 12 is also similar to the method of FIG. 7 in that the method of FIG. 12 includes receiving (702) data representing projected capacity utilization for at least one of the plurality of storage arrays, where the projected capacity utilization is generated (700) in dependence upon capacity utilization patterns of a plurality of other storage arrays and presenting (704) the projected capacity utilization.

The method of FIG. 12 differs from the method of FIG. 7, however, in that the method of FIG. 12 includes receiving (1204) input specifying a potential change in one or more performance settings of the storage array. Receiving (1204) such input may be carried out by through a GUI designated for such a purpose. A performance setting for a storage array is a setting related to a particular performance metric that when increased prioritizes that performance metric relative to others. Examples of performance settings include bandwidth, throughput, IOPS, Read/Write latency, data reduction ratio, and the like.

The method of FIG. 12 continues by generating (1208) an updated projected capacity utilization in dependence upon the potential change in the one or more performance settings of the storage array. That is, in some embodiments, the projected capacity utilization may be forecast capacity utilization in dependence upon a potential change in the system.

The method of FIG. 12 continues by receiving (1204) the updated projected capacity utilization (1210) and presenting (1206) the updated projected capacity utilization. In this way, a user may provide various potential performance setting changes to determine the projected effect of the changes on capacity utilization.

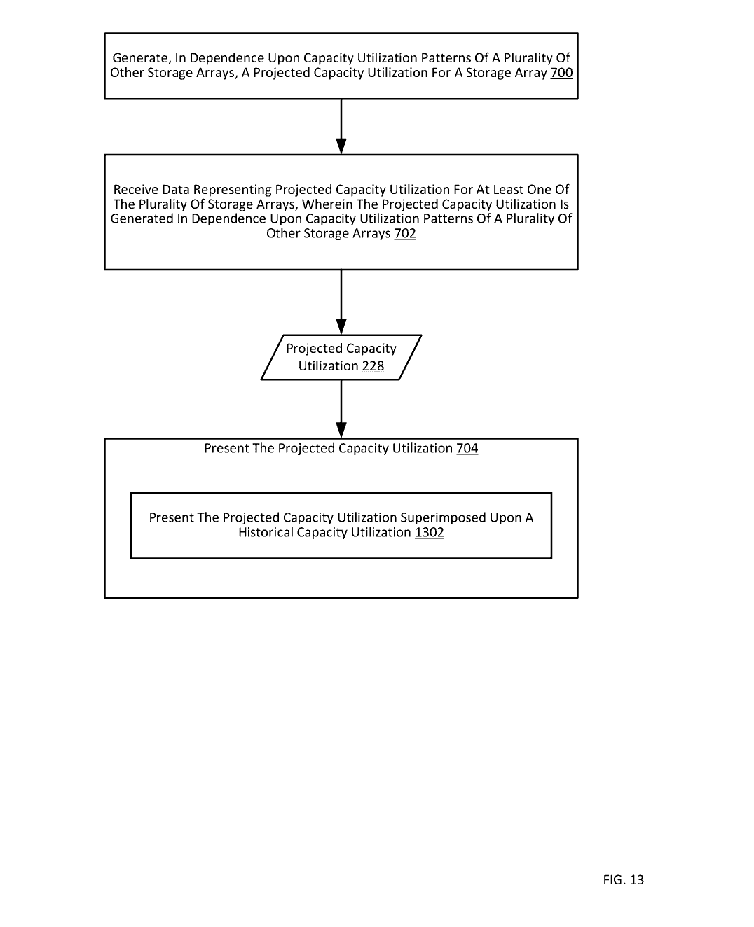

For further explanation, FIG. 13 sets forth a flow chart illustrating another exemplary method for capacity planning in a multi-array storage system according to embodiments of the present invention. The method of FIG. 13 is similar to the method of FIG. 7 in that portions of the FIG. 13 may be carried out by a cloud-based storage array services provider (176 in the example of FIG. 1), another cloud service module, a module executed by the storage controller of a storage array, or any combination thereof. The method of FIG. 13 is also similar to the method of FIG. 7 in that the method of FIG. 13 includes receiving (702) data representing projected capacity utilization for at least one of the plurality of storage arrays, where the projected capacity utilization is generated (700) in dependence upon capacity utilization patterns of a plurality of other storage arrays and presenting (704) the projected capacity utilization.

The method of FIG. 13 differs from the method of FIG. 7, however, in that, in the method of FIG. 13, presenting (704) the projected capacity utilization may include presenting (1302) the projected capacity utilization superimposed upon a historical capacity utilization. In this way, as described above, a user my determine whether the algorithm previously selected to project capacity utilization for the storage array is an accurate representation of the actual, historical capacity utilization of the storage array.

Exemplary embodiments of the present invention are described largely in the context of a fully functional computer system. Readers of skill in the art will recognize, however, that the present invention also may be embodied in a computer program product disposed upon computer readable media for use with any suitable data processing system. Such computer readable storage media may be any transitory or non-transitory media. Examples of such media include storage media for machine-readable information, including magnetic media, optical media, or other suitable media. Examples of such media also include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware, as hardware, or as an aggregation of hardware and software are well within the scope of embodiments of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of capacity planning in a multi-array system comprising a plurality of storage arrays, the method comprising:
receiving data representing projected capacity utilization for at least one of the plurality of storage arrays, wherein the projected capacity utilization is generated in dependence upon capacity utilization patterns of a plurality of other storage arrays; and
presenting the projected capacity utilization.

2. The method of claim 1, further comprising:
receiving input specifying a selection of a time period within which to project capacity utilization; and
updating the presentation of the projected capacity utilization responsive to the input.

3. The method of claim 1, wherein:
receiving data representing projected capacity utilization for at least one of the plurality of storage arrays further comprises receiving data representing projected capacity utilization for a plurality of storage arrays; and
presenting the projected capacity utilization further comprises presenting the projected capacity utilization of each of the plurality of storage arrays.

4. The method of claim 1, further comprising:
receiving a selection of a plurality of storage arrays in the multi-array system; and
updating the presentation of the projected capacity utilization to include projected capacity utilization of each of the selected storage arrays.

5. The method of claim 1, wherein the projected capacity utilization is further generated in dependence upon:
detecting a change in the presented projected capacity utilization; and
responsive to the change in the presented projected capacity utilization:
identifying a new date to which to project capacity utilization of the storage array; and
recalculating the projected capacity utilization of the storage array with the new date.

6. The method of claim 1, further comprising:
receiving input specifying a potential change in one or more performance settings of the storage array;
receiving an updated projected capacity utilization, the updated projected capacity utilization further generated in dependence upon the potential change in one or more performance settings of the storage array; and
presenting the updated projected capacity utilization.

7. The method of claim 1, wherein presenting the projected capacity utilization further comprises presenting the projected capacity utilization superimposed upon a historical capacity utilization.

8. An apparatus for capacity planning in a multi-array system comprising a plurality of storage arrays, the apparatus comprising a computer processor, a computer memory operatively coupled to the computer processor, the computer memory having disposed within it computer program instructions that, when executed by the computer processor, cause the apparatus to carry out the steps of:
receiving data representing projected capacity utilization for at least one of the plurality of storage arrays, wherein the projected capacity utilization is generated in dependence upon capacity utilization patterns of a plurality of other storage arrays; and
presenting the projected capacity utilization.

9. The apparatus of claim 8, further comprising computer program instructions that, when executed by the computer processor, cause the apparatus to carry out the steps of:
receiving input specifying a selection of a time period within which to project capacity utilization; and
updating the presentation of the projected capacity utilization responsive to the input.

10. The apparatus of claim 8, wherein:
receiving data representing projected capacity utilization for at least one of the plurality of storage arrays further comprises receiving data representing projected capacity utilization for a plurality of storage arrays; and
presenting the projected capacity utilization further comprises presenting the projected capacity utilization of each of the plurality of storage arrays.

11. The apparatus of claim 8, further comprising computer program instructions that, when executed by the computer processor, cause the apparatus to carry out the steps of:
receiving a selection of a plurality of storage arrays in the multi-array system; and
updating the presentation of the projected capacity utilization to include projected capacity utilization of each of the selected storage arrays.

12. The apparatus of claim 8, wherein the projected capacity utilization is further generated in dependence upon:
detecting a change in the presented projected capacity utilization; and
responsive to the change in the presented projected capacity utilization:
identifying a new date to which to project capacity utilization of the storage array; and
recalculating the projected capacity utilization of the storage array with the new date.

13. The apparatus of claim 8, further comprising computer program instructions that, when executed by the computer processor, cause the apparatus to carry out the steps of:
receiving input specifying a potential change in one or more performance settings of the storage array;
receiving an updated projected capacity utilization, the updated projected capacity utilization further generated in dependence upon the potential change in one or more performance settings of the storage array; and
presenting the updated projected capacity utilization.

14. The apparatus of claim 8, wherein presenting the projected capacity utilization further comprises presenting the projected capacity utilization superimposed upon a historical capacity utilization.

15. A computer program product for capacity planning in a multi-array system comprising a plurality of storage arrays, the computer program product disposed upon a computer readable medium, the computer program product comprising computer program instructions that, when executed, cause a computer to carry out the steps of:
receiving data representing projected capacity utilization for at least one of the plurality of storage arrays, wherein the projected capacity utilization is generated in dependence upon capacity utilization patterns of a plurality of other storage arrays; and
presenting the projected capacity utilization.

16. The computer program product of claim 15, further comprising computer program instructions that, when executed, cause the computer to carry out the steps of:
receiving input specifying a selection of a time period within which to project capacity utilization; and
updating the presentation of the projected capacity utilization responsive to the input.

17. The computer program product of claim 15, wherein:
receiving data representing projected capacity utilization for at least one of the plurality of storage arrays further comprises receiving data representing projected capacity utilization for a plurality of storage arrays; and
presenting the projected capacity utilization further comprises presenting the projected capacity utilization of each of the plurality of storage arrays.

18. The computer program product of claim 15, further comprising computer program instructions that, when executed, cause the computer to carry out the steps of:
receiving a selection of a plurality of storage arrays in the multi-array system; and
updating the presentation of the projected capacity utilization to include projected capacity utilization of each of the selected storage arrays.

19. The computer program product of claim 15, wherein the projected capacity utilization is further generated in dependence upon:
detecting a change in the presented projected capacity utilization; and
responsive to the change in the presented projected capacity utilization:
identifying a new date to which to project capacity utilization of the storage array; and
recalculating the projected capacity utilization of the storage array with the new date.

20. The computer program product of claim 15, further comprising computer program instructions that, when executed, cause the computer to carry out the steps of:
receiving input specifying a potential change in one or more performance settings of the storage array;
receiving an updated projected capacity utilization, the updated projected capacity utilization further generated in dependence upon the potential change in one or more performance settings of the storage array; and
presenting the updated projected capacity utilization.
